(19) United States
(12) Patent Application Publication
(10) Pub. No.: US 2010/0090936 A1
(43) Pub. Date: Apr. 15, 2010

(54) Layered Color Display

(76) Inventors: Charles G. Dupuy, Corvallis, OR (US); William A. Fischer, Corvallis, OR (US); Joseph W. Stellbrink, Lebanon, OR (US); Peter J. Fricke, Corvallis, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/251,066

(22) Filed: Oct. 14, 2008

(51) Int. Cl. G09G 3/36

(52) U.S. Cl. 345/88

(57) ABSTRACT

Devices, systems, mediums, and methods for providing a layered color display are disclosed. One method of displaying images includes configuring a reflective color display in a layered manner to display a first portion of an image in a lower layer and to display a second portion of an image in a number of upper layers by decoupling imaging functions of a number of upper layers of a reflective color display device from imaging functions of a lower layer of a reflective color device, driving the lower layer with an active matrix back plane thin film transistor (TFT), and addressing the number of upper layers passively.

### INTRODUCTION

A reflective color display device can present information (e.g., text and/or images) to a viewer by providing a reflective surface below layers of pixels that can be electrically charged to form the image and/or text to be displayed. In some implementations, a reflective color display uses an approach that is similar to the method used in an emissive display, such as a liquid crystal display (LCD) or plasma display. In these emissive displays (e.g., backlit), color filters or individual color primaries are placed adjacent to each other and combined in an additive manner to generate various colors.

In some implementations, a single-layer monochrome display can be used with a color filter or unique red, green, and/or blue colorants, for example, to generate additive mixture of colors. In this single-layer approach each pixel can be addressed by a single layer of electronics, enabling active-matrix electronics to be used for fast pixel addressing or maintaining a holding voltage.

Due to the side by side nature of such arrangements these arrangements can be inefficient, as about one-third of the display can be used to generate each red, green, and/or blue (RGB) sub-band of visible wavelengths. In some such display concepts, an emissive display can compensate for this optical inefficiency by using electrical power to generate additional light; but for reflective displays, the result is a dim gamut of colors relative to what consumers may be accustomed to seeing from either emissive displays or printed media. For example, an RGB stripe reflective display may reflect a maximum of about 33% of ambient light while newsprint reflects over 55% of the reflected light and plain paper reflects close to 80% of the available illumination.

One approach for creating a lighter white state is to devote a portion of the color filter, typically one-fourth, to white. With this approach, white and light neutral colors are brighter, but the colorfulness of the display is decreased because a smaller portion of the color filter is devoted to each RGB primary. The red, green, and blue (RGB) and red, blue, and white color model (RBW) stripe approaches have limited image quality potential relative to printed output in many instances.

To achieve a true high-quality reflective display, each primary color should be addressable at each image location, not only a portion of the display. Reflective displays with typically the highest visual quality may utilize multiple color layers either mixed or stacked on top of each other, unless the colors to be utilized can be mixed into a single, pixel. Without layered or mixed colorants, the resulting lightness and colorfulness will be limited due to areas which are unable to generate the desired color, thus essentially become inactive for certain colors.

Though the stacked color approach provides the highest image quality potential, there are practical challenges of constructing and electrically addressing multiple display layers. Geometric light loss effects, viewing parallax, layer-to-layer registration, and/or simultaneously addressing four monochrome displays are some of the practical challenges in constructing a multi-layers reflective color display.

### BRIEF DESCRIPTION OF THE DRAWINGS

FIG. 1 illustrates a pixel on a reflective color display with a lower layer and a number of upper layers according to an embodiment of the present disclosure.

FIG. 2 illustrates a pixel on a reflective color display with a TFT on a lower layer and a number of bistable upper layers according to an embodiment of the present disclosure.

FIG. 3 illustrates a pixel array on a reflective color display having a lower layer with greater spatial resolution than a number of upper layers according to an embodiment of the present disclosure.

FIG. 4 is a block diagram illustrating a method of displaying images according to an embodiment of the present disclosure.

### DETAILED DESCRIPTION

The present disclosure describes a reflective color display system that includes a lower imaging plane, where the lower imaging plane includes an array of pixels, and a number of upper imaging planes, where the number of upper imaging planes each include an array of pixels, and where the lower imaging plane and the number of upper imaging planes are combined together to display an image on a reflective color display. In some embodiments, the number of imaging functions of the lower imaging plane can be decoupled from a number imaging functions of the number of upper imaging planes.

The lower imaging plane can be driven by an active matrix back plane thin film transistor (TFT) and the number of upper imaging planes can be addressed passively, in various embodiments. In such embodiments, by providing an active matrix back plane TFT transistor, a reflective color display can have a lower layer to display image information with a fast temporal response that supports rapid refreshing of image information (e.g., video-rate viewing). By decoupling the upper imaging planes from the lower imaging plane, in some embodiments, the display can be manufactured to avoid the cost of TFT circuitry at each layer, while still displaying images with a high level of spatial and/or tonal resolution.

Such a technology can, among various other implementations, be used to mimic the appearance of text and/or images on paper (e.g., using ink) because colors of an original document can be reproduced. In some embodiments, the reflective color display can achieve reflectivity in the range of 50% to 90%, among other suitable percentages.

Accordingly, among various embodiments of the present disclosure, displaying images in a reflective color display can be performed by configuring a reflective color display to display the black portion and/or a portion of the image that includes multiple colors in a single pixel in a lower layer and to display the remaining color portion and/or black portion of an image in a number of upper layers by driving the lower layer with an active matrix (AM) thin film transistor (TFT) drive scheme and addressing the number of upper layers passively. Those of ordinary skill in the art will understand that the terms upper and lower are provided to give the reader an understanding of how the layers are oriented with respect to each other and not how the layers are oriented spatially.

Accordingly the upper layers may be positioned below the lower layer spatially, but with respect to the layer's orientation for transmitting light, the upper layers are above the lower layer. Also, those skilled in the art will recognize the colors associated with the various layers in these examples are not intended to be exclusive or limiting. Accordingly, the pixels in each layer can contain any color, any number of colors, and/or any combination of colors.

Such a configuration can be accomplished by decoupling a number of imaging functions of the lower layer from a number imaging functions of the upper layers. The spatial and/or tonal resolution of the number of upper levels can be less than the spatial and/or tonal resolution of the lower level and thus the pixel density can be lower in the number of upper layers than in the lower layer.

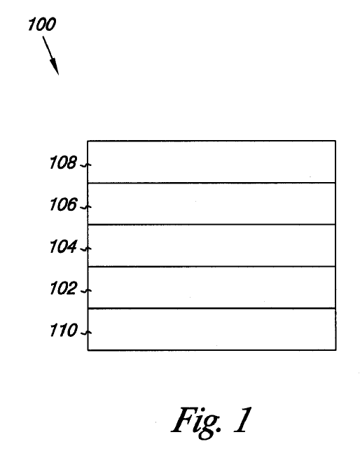

FIG. 1 illustrates a pixel on a reflective color display with a lower layer and a number of upper layers according to an embodiment of the present disclosure. FIG. 1 shows by way of illustration how the display 100, in some instances, may use a lower layer 102, which can display the black or the achromatic high-frequency portion of an image, and a number of upper layers 104, 106, and 108, which can display the color portion of an image.

In the embodiment illustrated in FIG. 1, three upper layers are used for illustration purposes only. In various embodiments, any number of upper layers can be used and the pixels in each upper layer can include any color or color combination.

As shown in FIG. 1, the pixel can include a reflective surface 110 to reflect ambient light to display the color that is generated by the layers of the pixel. The color that is generated by the layers of the pixel can be part of the image and/or text that is formed by an array of pixels on a reflective color display.

In various embodiments, the number of upper color layers 104, 106, and 108 can include a cyan, a magenta, a yellow, a red, a green, a blue, and/or a black layer, among others. In some embodiments, these layers along with a lower, high spatial resolution layer 102 can be used in a subtractive cyan, magenta, yellow, and key (black) (CMYK) system to form the color of the pixel.

In various embodiments, the upper layers can be addressed passively. In some embodiments, the upper layers can include a bistable pixel technology to be addressed passively. The bistable nature of the upper layers can include a long retention time for the addressing of the pixels and/or a threshold for the passive addressing of the layers.

The upper layers and/or the lower layer can have their imaging functions decoupled from each other, where the temporal response and the spatial and/or tonal resolution are separate, among other imaging function and/or metrics of the display. With decoupled imaging functions, the upper and lower layers can have different electronic drive schemes and/or addressing schemes for the pixels in each of the respective layers.

The lower layer can provide the achromatic high resolution information for the pixel, which can provide the majority of the imaging information. In such embodiments, when the lower layer (i.e. black layer and/or a layer that provides high resolution image information for more than one color per pixel) provides the majority of imaging information, a fast update time can be helpful to allow rapid viewing and changing of imaging information.

This fast update time can allow for a quick perusal of a large number of images and/or text over a short period of time. In some embodiments, the display can, for example, have a refresh time of less than 0.5 seconds per page for the lower layer. In some embodiments, the lower layer can have a refresh rate of 30 Hertz (Hz) or greater to provide video quality imaging.

The upper layers can provide lower resolution information for the images and/or text of the display, which can include the chromatic information that is not provided in the lower layer. The chromatic information can add to the overall image and/or text, but may not be an essential aspect in providing the majority of the details that form the image and/or text, which can, for example, be done with the high resolution layer. Therefore, the upper layers can have a lower update time, spatial resolution, and/or tonal resolution, while still providing their function of improving the overall image quality when combined with the high resolution layer for images that are intended to be viewed with more than a quick perusal, in some instances.

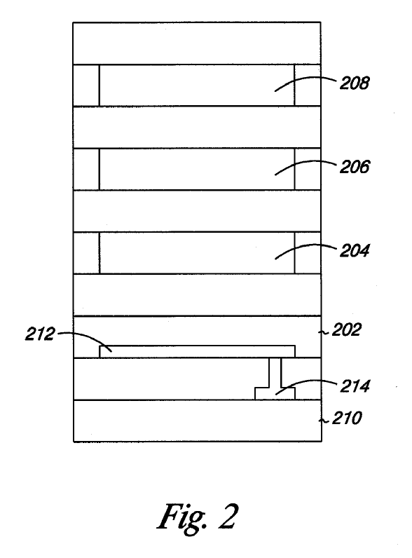

FIG. 2 illustrates a pixel on a reflective color display with a TFT on a lower layer and a number of bistable upper layers according to an embodiment of the present disclosure. In the embodiment of FIG. 2, a lower layer 202 can be coupled to an electrode 212 and a transistor 214. The transistor 214 can act as the gate to pass an electrical charge to electrode 212 and turn on the lower layer 202 to display the black colorant of the pixel.

The lower layer 202 can be a portion of a pixel, which can be coupled to a transistor 214, that can be part of an array of pixels that are all coupled to transistors. The array of pixels can be electrically addressed by an active matrix TFT drive scheme. An active matrix TFT drive scheme can allow the each pixel in the lower layer to be addressed individually and updated frequently and/or have a large number of pixels in a given area, as the electronics of an active matrix TFT drive scheme and their configuration can increase the pixel density in a certain area.

In some embodiments, an active matrix display device can include an array of pixels arranged in rows and columns. Each row of pixels can share, for example, a row conductor which connects to the gates of the thin film transistors of the pixels in the row.

Each column of pixels shares a column conductor, to which pixel drive signals are provided. In various embodiments, the signal on the row conductor determines whether the transistor is turned on or off, and when the transistor is turned on, by a high voltage pulse on the row conductor, a signal from the column conductor can be allowed to pass on to an area of liquid crystal material (or other capacitive display area), thereby altering the light transmission characteristics of the material.

In various embodiments, the frame period for active matrix display devices can allow for a row of pixels to be addressed in a short period of time, and this places a limit on the current driving capabilities of the transistor in order to charge or discharge the liquid crystal material to the desired voltage level. In order to meet these current requirements, the gate voltage supplied to the thin film transistor needs large voltage swings.

For example, in a display using low temperature polysilicon transistors, a minimum row drive voltage may be around −2 Volts and a maximum around 15 Volts. This ensures the transistor is biased sufficiently to provide the required source-drain current to charge or discharge the liquid crystal material sufficiently rapidly. Those of ordinary skill in the art will recognize that the embodiments of the present disclosure are not limited to such voltages.

In some embodiments, the lower layer 202 can be part of a pixel array that can have a resolution of 150 pixels per inch (ppi). The lower layer can provide the spatial resolution to include the high spatial frequency information of the images to provide the high-contrast edges of the images and/or text on the display. The lower layer can, in some embodiments, provide higher tonal resolution to enable the display of fine tonal gradations and detail often present in the achromatic information, but that may be missing from the chromatic information.

In the embodiment of FIG. 2, the upper layers 204, 206, and 208 can include a layered pixel configuration where each layer corresponds to a color in a CMY subtractive imaging scheme, among other imaging schemes. For instance, layer 204 can be a cyan layer, layer 206 can be a magenta layer, and layer 208 can be a yellow layer. The layers 204, 206, and 208 can be separated by one or more transparent layers, such as glass or indium tin oxide (ITO).

In some embodiments, bistable pixels can be used in the upper layers 204, 206, and/or 208 of the display. Pixel bistability can be a desirable attribute for a display because it can reduce or eliminate having to quickly refresh the display and/or to employ a silicon memory device behind each pixel, which may become expensive as the number of pixels increases, in some instances. With bistability, only pixels that have to be changed may have addressing, and therefore a simpler matrix addressing may be employed, in some situations.

In such embodiments, a bistable pixel technology can be implemented in the upper layers 204, 206, and 208. A variety of bistable, electrophoretic pixel configurations, such as in-plane Electrophoretic (IPEP) and electrophoretically controlled nematic (EPCN), among other pixel types, can be used in the upper layers so the layers can be addressed passively, in various embodiments. Passive addressing of the upper layers can, for example, provide the necessary temporal response, spatial resolution, and/or tonal resolution for the display while implementing an electronics scheme that is easier and/or cheaper to produce than an active matrix drive scheme, in some instances.

Bistable LCDs having chiral tilted smectic liquid crystals, for example chiral smectic C materials, which exhibit ferroelectricity have been devised. However, ferroelectric LCDs may not be useful in some instances, because they may have a paucity of stable, room-temperature materials, wide-temperature-range materials, and/or structural defects which can result from mechanical stress, among other issues. Because of the issues associated with ferroelectric smectic materials it may be useful to fabricate bistable LCDs using nematic liquid crystals (“LCs”), in some situations.

In some embodiments, electrophoretically controlled nematic (EPCN) pixels can be used in the upper layers 204, 206, and/or 208 of the display. In some embodiments, an electrophoretically controlled bistable liquid crystal pixel configuration can be used, for example, where a liquid crystal material can be switched from one or more stable molecular configurations by the application to an electrode of a direct current (DC) electric field pulse of suitable field strength and duration to cause movement of charged particles to and/or from a cell wall so as to reduce or prevent the first surface alignment from influencing alignment of molecules of liquid crystal material in the layer.

In various embodiments, the nature of the molecular configurations in an EPCN pixel depends on the surface alignments. A combination of planar alignment at one surface and homeotropic alignment at the other provides, for example, a homeoplanar alignment which can be stably switched to a homeotropic alignment. A combination of planar alignments at both surfaces with the alignment directions different (e.g. at 90° to each other) provides an initial twisted nematic structure which can be selectively realigned to either of two homeoplanar alignments with the planar direction determined by one or other of the surface alignments.

In various embodiments, the lower layer 202 and the number of upper layers 204, 206, and 208 can be addressed in parallel with a multiline addressing configuration. Multiline addressing includes selecting multiple rows of pixels in a pixel matrix with a voltage potential on each the selected rows and then addressing the individual pixels on a given row with another voltage potential to turn the pixel on.

In various embodiments, the lower layer 202 and the number of upper layers 204, 206, and 208 can be addressed line by line in a scanning configuration. Addressing line by line in a scanning configuration includes selecting an individual row in a pixel matrix with a voltage potential and then turning the desired pixels in the row on with a voltage potential with another voltage potential from a column signal. In such embodiments, the pixel matrix can be scanned by sequentially selecting or not selecting each row of pixels one after another.

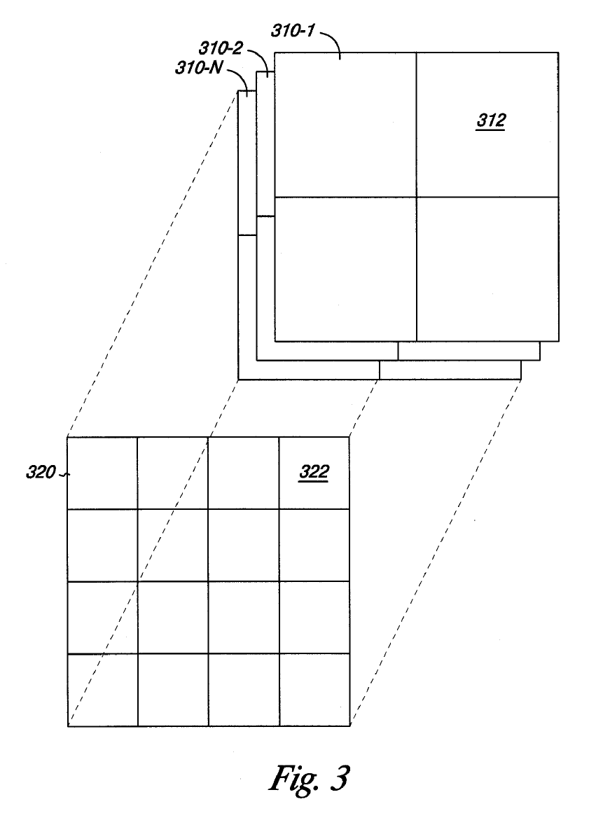

FIG. 3 illustrates a pixel array on a reflective color display having a lower layer with greater spatial resolution than a number of upper layers according to an embodiment of the present disclosure. In the embodiment of FIG. 3, the pixel array includes a number of upper layers 310-1, 310-2, and 310-N stacked on top of each other, where pixel 312 is part of upper layer 310-1.

In some embodiments, the lower layer can, for example, have a resolution of 150 pixels per inch (ppi) and the upper layers can each have a resolution of 75 ppi, resulting in four fold fewer address lines for each of the upper layers as compared to the lower layer. Those of ordinary skill in the art will recognize that the embodiments of the present disclosure are not limited to such examples of resolution.

In some embodiments, the lower layer 320, such as in FIG. 3, can include a number of pixels, one of which is pixel 322. In the pixel array of the embodiment of FIG. 3, the pixel array has a lower layer with a spatial resolution of 150 ppi. The increase in the spatial resolution of the lower layer can allow for greater detail for the black and/or high resolution portion of the image and/or text, which can be where a majority of the imaging information is located in the image and/or text, in many instances.

In the embodiment of FIG. 3, the pixels for the number of upper layers 310-1, 310-2, and 310-N can include the cyan, yellow, magenta, red, green, blue, and/or black, among other colors, portion of the pixel information, which is not indicated in FIG. 3, with the high frequency portion of the image provided from the lower level to form any color desired for the pixel or pixels of the image and/or text.

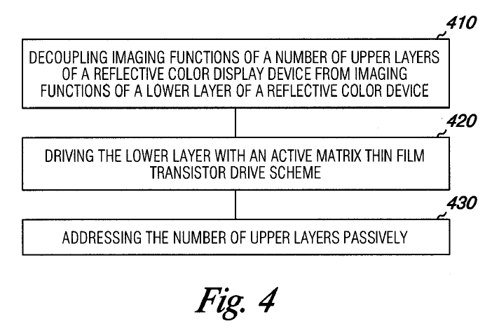

FIG. 4 is a block diagram illustrating a method of displaying images according to an embodiment of the present disclosure. In some embodiments, a medium having executable instructions stored thereon for executing a method of displaying images in a reflective color display device can include decoupling imaging functions of a number of upper layers of a reflective color display device from imaging functions of a bottom layer of a reflective color device 410, driving the lower layer with an active matrix back plane thin film transistor (TFT) 420, and addressing the number of upper layers passively 430.

In various embodiments, decoupling imaging functions of the number of upper layers from imaging functions of the lower layer includes providing a first temporal response metric to the number of upper layers and a second temporal response metric to the lower layer. In some embodiments, the temporal response metric of the lower layer provides a faster refresh time than the temporal response metric of the number of upper layers.

In various embodiments, decoupling imaging functions of the number of upper layers from imaging functions of the lower layer includes providing a first spatial resolution to the number of upper layers and a second a spatial resolution to the lower layer. In some embodiments, the spatial resolution of the lower layer is greater than the spatial resolution of the number of upper layers.

In various embodiments, decoupling imaging functions of the number of upper layers from imaging functions of the lower layer can be accomplished by providing a first tonal resolution to the number of upper layers and a second tonal resolution to the lower layer. In some embodiments, the tonal resolution of the lower layer can be greater than the tonal resolution of the number of upper layers. In such embodiments, where the tonal resolution of the number of upper layers is less than the lower layer, the electrical drive scheme for the number of upper layers can be passive due to the reduction in the number of tonal levels in the number of upper layers.

In various embodiments, the method includes using the lower layer to display the high-frequency, achromatic information of the images and the upper layers to display the chromatic information of the images. Grey component replacement or other techniques can be sued to convert as much information as possible into a separate achromatic channel. In some embodiments, the method includes a driver for the active matrix back plane of the lower layer and a driver for the passive matrix of the upper layers and demultiplexing data to send a portion of the data to the lower layer and a portion of the data to the number of upper layers.

Some such embodiments can provide, for example, a reflective display having a high optical efficiency, similar to the optical efficiency of paper. Some embodiments can provide a refresh time to allow a quick perusal of images and/or text, along with a quick response to inputs that change the displayed images and/or text.

Although specific embodiments have been illustrated and described herein, those of ordinary skill in the relevant art will appreciate that an arrangement calculated to achieve the same techniques can be substituted for the specific embodiments shown. This disclosure is intended to cover all adaptations or variations of various embodiments of the present disclosure.

It is to be understood that the above description has been made in an illustrative fashion, and not a restrictive one. Combination of the above embodiments, and other embodiments not specifically described herein, will be apparent to those of ordinary skill in the relevant art upon reviewing the above description.

The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure need to use more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method of displaying images, comprising:
configuring a reflective color display in a layered manner to display a first portion of an image in a lower layer and to display a second portion of an image in a number of upper layers by:
decoupling an electrical drive scheme of the lower layer from an electrical drive scheme of the number of upper layers, where a number of imaging functions of the lower layer are independent of a number of imaging functions of the number of uppers layers.

2. The method of claim 1, wherein the method includes addressing the number of upper layers in parallel with a multiline addressing configuration.

3. The method of claim 1, wherein the method includes addressing the lower layer actively by addressing pixels line by line in a scanning configuration.

4. The method of claim 1, wherein the method includes addressing the lower layer actively by addressing pixels in parallel with a multiline addressing configuration.

5. The method of claim 1, wherein the method includes addressing the number of upper layers by addressing pixels line by line in a scanning configuration.

6. The method of claim 5, wherein the method includes providing a spatial resolution of the number of upper levels that is less than the spatial resolution of the lower level.

7. The method of claim 5, wherein the method includes providing a lower pixel density in the number of upper layers than in the lower layer.

8. The method of claim 5, wherein the method includes providing a tonal resolution of the number of upper layers that is less than the tonal resolution of the lower level.

9. The method of claim 1, wherein the method includes providing a number of upper layers where the uppers layers are selected from a group of color layers including: magenta, yellow, cyan, red, green, blue, and black.

10. A device readable medium having executable instructions stored thereon for executing a method of displaying images in a reflective color display device, comprising:
decoupling imaging functions of a number of upper layers of a reflective color display device from imaging functions of a lower layer of a reflective color device;
driving the lower layer with an active matrix back plane thin film transistor (TFT); and
addressing the number of upper layers passively.

11. The medium of claim 10, wherein decoupling imaging functions of the number of upper layers from imaging functions of the lower layer includes providing a first temporal response metric to the number of upper layers and a second temporal response metric to the lower layer and where the temporal response metric of the lower layer provides a faster refresh time than the temporal response metric of the number of upper layers.

12. The medium of claim 10, wherein decoupling imaging functions of the number of upper layers from imaging functions of the lower layer includes providing a first tonal resolution to the number of upper layers and a second tonal resolution to the lower layer and where the tonal resolution of the lower layer is greater than the tonal resolution of the number of upper layers.

13. The medium of claim 10, wherein decoupling imaging functions of the number of upper layers from imaging functions of the lower layer includes providing a first spatial resolution to the number of upper layers and a second a spatial resolution to the lower layer and where the spatial resolution of the lower layer is greater than the spatial resolution of the number of upper layers.

14. The medium of claim 10, wherein the method includes using the lower layer to display image information of a number of colors and where a number of pixels in the lower layer each contain image information for one or more upper layers.

15. The medium of claim 14, wherein the method includes a driver for the active matrix back plane of the lower layer and a driver for the passive matrix of the upper layers and demultiplexing data to send a portion of the data to the lower layer and a portion of the data to the number of upper layers.

16. A reflective color display system, comprising:
a lower imaging plane, where the lower imaging plane includes an array of pixels; and
a number of upper imaging planes, where the number of upper imaging planes each include an array of pixels, and
where image information from the lower imaging plane and image information from the number of upper imaging planes are combined together to display an image on a reflective color display.

17. The system of claim 16, wherein the lower imaging plane is driven by an active matrix back plane thin film transistor (TFT) and the number of upper imaging planes are addressed passively.

18. The system of claim 17, wherein the number of upper imaging planes are addressed passively by parallel multiline addressing.

19. The system of claim 17, wherein the lower imaging plane and the number of upper imaging planes are addressed by addressing the pixels line by line in a scanning configuration.

20. The system of claim 17, wherein the lower imaging plane is addressed actively by addressing the pixels in parallel with a multiline addressing configuration.

21. The system of claim 16, wherein a number of imaging functions of the lower imaging plane are decoupled from a number imaging functions of the number of upper imaging planes.

22. The system of claim 21, wherein a temporal response metric of the lower imaging plane provides a faster refresh time than a temporal response metric of the number of upper imaging planes.

23. The system of claim 21, wherein a spatial resolution of the lower imaging plane is greater than a spatial resolution of the number of upper imaging planes.

24. The system of claim 21, wherein a tonal resolution of the lower imaging plane is greater than a tonal resolution of the number of upper imaging planes.

25. The system of claim 17, wherein the number of upper imaging planes are selected from a group of color layers including: magenta, yellow, cyan, red, green, blue, and black
